(19) United States
(12) Patent Application Publication
(10) Pub. No.: US 2016/0176737 A1
(43) Pub. Date: Jun. 23, 2016

(54) FRACKING WASTE-WATER FILTRATION APPARATUS AND METHOD

(71) Applicant: Water Works Services, LLC, Chaska, MN (US)

(72) Inventor: David Ralph Erickson, Chaska, MN (US)

(21) Appl. No.: 14/573,627

(22) Filed: Dec. 17, 2014

(51) Int. Cl. C02F 9/00; C02F 1/24; C01B 5/00; C02F 1/463

(52) U.S. Cl. CPC C02F 9/00; C02F 1/463; C02F 1/24; C01B 5/00; C02F 2103/10

(57) ABSTRACT

A water treatment system for fracking waste water, the system providing a combination of treatment units adapted to be provided in the form of one or more transportable modules. A corresponding method of treating waste water by the use of such a system, and water that has been treated by the use of the method.

### RELATED MATTERS

This non-provisional application relates to U.S. provisional application Ser. No. 61/680,494, filed Aug. 7, 2012 and U.S. provisional application Ser. No. 61/893,343, filed Oct. 21, 2013, both of which are incorporated herein by reference.

### FIELD

The invention generally relates to water filtration, and more specifically to filtration of water that has been used in an industrial application, such as during a hydraulic fracturing operation.

### BRIEF DESCRIPTION OF THE DRAWINGS

The following drawings are illustrative of particular embodiments of the invention and therefore do not limit the scope of the invention. The drawings are not necessarily to scale (unless so stated) and are intended for use in conjunction with the explanations in the following detailed description. Embodiments of the invention will hereinafter be described in conjunction with the appended drawings, wherein like numerals denote like elements.

FIG. 1 is a schematic layout of the constituent parts of a water treatment system according to some embodiments.

FIG. 2 is a schematic layout of some of the constituent parts of a water treatment system according to some embodiments.

FIG. 3 is a flow-chart of the operational steps of a water treatment system, according to some embodiments.

### DETAILED DESCRIPTION OF ILLUSTRATIVE EMBODIMENTS

The following detailed description is exemplary in nature and is not intended to limit the scope, applicability, or configuration of the invention in any way. Rather, the following description provides some practical illustrations for implementing exemplary embodiments of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

The basic fracking operation is well known to the oil and gas producing industry. During a hydraulic fracturing operation, water is pumped down a well head and is caused to penetrate underground formations by the application of sufficient pressure to the water. This releases material (e.g., hydrocarbons, suspended solids, dissolved solids, metals, etc.) that can be useful in a variety of applications. When the fracking operation is complete, the pressure is released, and some of the water flows back up the well head and is captured.

In many cases, the water recovered from a well can be contaminated with hydrocarbons, suspended solids, dissolved solids, metals, bacteria and/or other contaminants. The recovered water must therefore be treated before it can be released into the environment, or before it can be re-used in the fracking process. Some approaches to treating fracking waste water involve using an off-site water treatment facility (a water treatment plant). Using an off-site water treatment facility requires transporting waste water to the facility, which is often accomplished by truck transport.

An off-site water treatment facility can have various water treatment and water filtration equipment to treat waste water. In some cases, waste water can be passed through the equipment over a long period of time, for example, an off-site water treatment facility can have a large pit which functions to treat waste water through dissolved air floatation. In such a pit, air can be bubbled into the waste water which can be slowly circulated over the course of several days. Some contaminants eventually float to the top and can be skimmed off, while other contaminants fall to the bottom where they can be filtered through sand that can be located at the bottom of the pit. Once waste water has been treated at the facility, it can be sent to various sites, again often by truck.

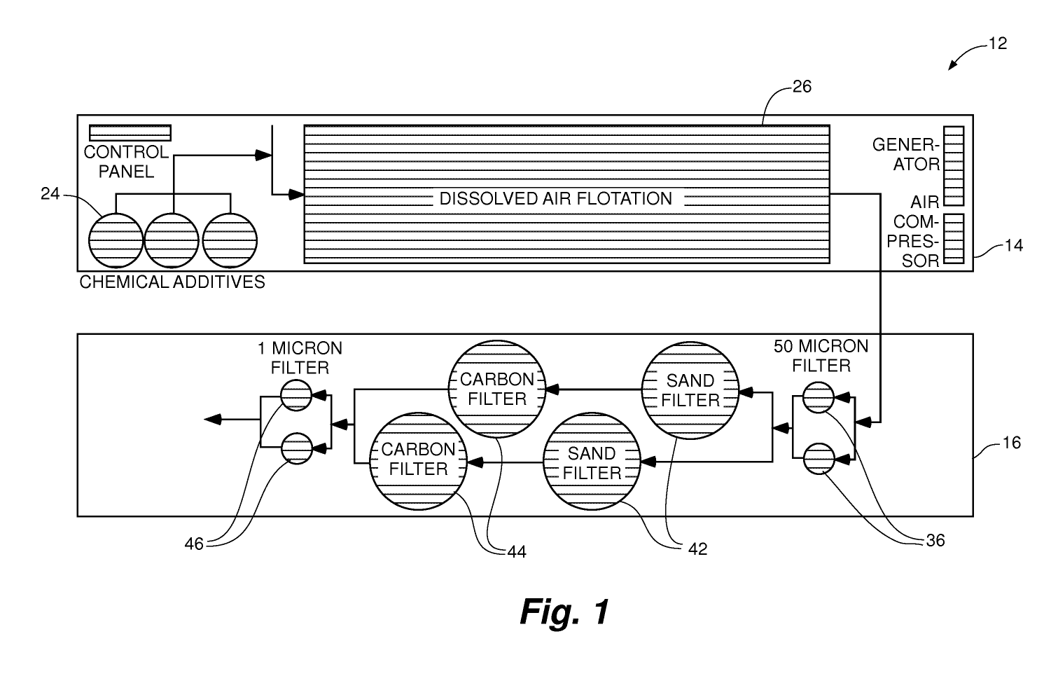

Treating waste water locally—at the well site as opposed to at a remote treatment facility—can provide considerable savings due to the reduction in waste water transportation costs. The water treatment system 12, according to some embodiments, can itself be transported to a drilling site, and within a short period of time, be ready to filter fracking waste water. In FIG. 1 the general layout of the constituent parts of an illustrative water treatment system is shown. FIG. 1 schematically depicts the water treatment system 12 which can be provided in two modules, a first module 14 and a second module 16. Each module 14, 16 can be contained within a single trailer (e.g., a trailer that is approximately 53 feet long), which can simplify the transportation and set-up of the system 12.

According to some embodiments, waste water can be passed through filtering equipment which can reduce the Total Suspended Solids (TSS), Total dissolved Solids (TDS), metals and bacteria in the water and can return the water's pH level to neutral. This can be accomplished through treatment by the water treatment system 12 independently, or alternatively water treatment can be accomplished in conjunction with other equipment, which can be ancillary to water treatment system 12. After treatment, treated waste water can then be reused for further fracking operations or discharged without deep well injection.

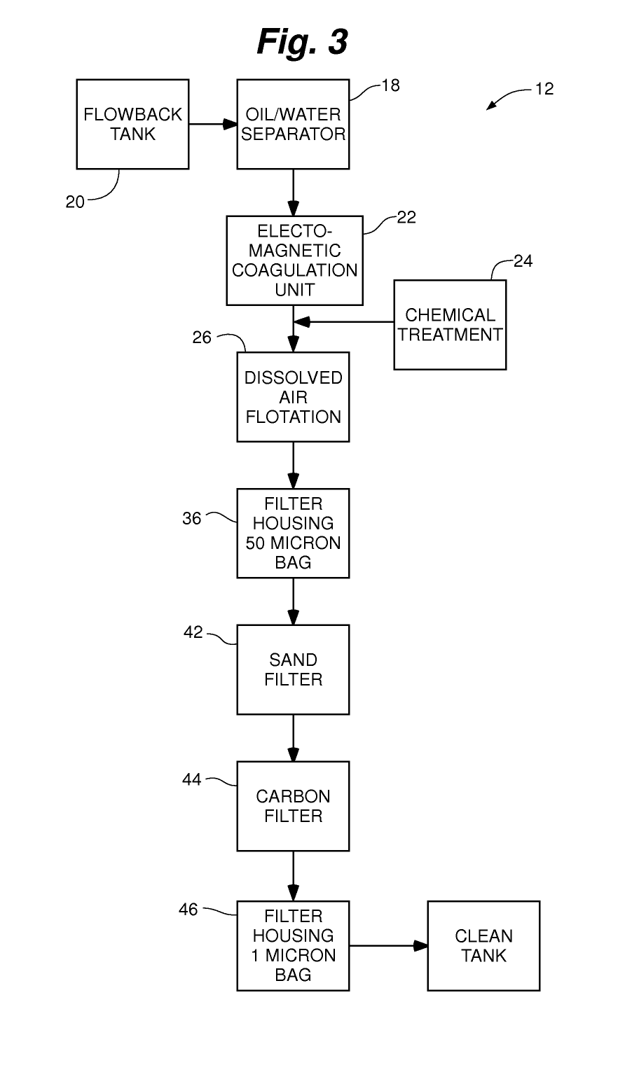

FIG. 3 shows a flow-chart, which depicts the operational steps of the water treatment system 12 of some embodiments. Fracking waste water can be collected in a flowback tank 20. Different configurations of flowback tank 20 can be possible, some configurations can include a multi-zone flowback tank. The selection of a particular flowback tank 20 configuration can depend on the preferences of the fracking driller operator. The water can then flow through a standard oil and water separator 18 that is designed and operated according to the American Petroleum Institute's design guidelines. The separator 18 can be used to separate free and finely dispersed oil droplets from an oily waste water stream. The use of an oil and water separator 18 can be optional, according to some embodiments, and the oil and water separator 18 can be provided in a separate module, which can be contained within a third trailer.

In some embodiments, the first module 14 can have an electrocoagulation machine 22, which can involve passing water between two electrically charged metal electrodes in order to promote the coagulation of suspended solid contaminants, and thus their removal. The applied electrical charge can neutralize contaminants, while at the same time, the electrical charge can liberate metal ions from the surfaces of the electrodes. The liberated metal ions can then create metal hydroxides that can aid in the coagulation of the water contaminants into a larger mass that can then be more easily removed by subsequent water treatment steps, such as by dissolved air floatation and filtration, as two examples. In the electrocoagulation machine 22, fourteen metal tubes 34 can be positioned to carry the flow of waste water and function as a first electrode. Inside each of the metal tubes 34, a coaxial rod 32 can be placed at approximately the center of the metal tube 34 to function as a second electrode. The metal tubes 34 can be 8 inches in diameter. A negative electrical charge can be applied to the coaxial rods 32 (which can then function as a cathode), while a positive electrical charge can be applied to the metal tubes 34 (which can then function as an anode), and the waste water is then permitted to flow through the metal tubes 34. An electrical supply of 220 volts DC (direct current) and 30 amps (amperes) can be supplied to the electrocoagulation machine 22.

According to some embodiments, some of the metal tubes 34 can be made from stainless steel, while some of the tubes can be made from carbon steel. In some embodiments, seven of the fourteen tubes can be made from stainless steel, while seven of the tubes can be made from carbon steel. In some embodiments, some of the coaxial rods 32 can be made from carbon steel, some of the coaxial rods can be made from zinc (or zinc alloys) and some of the coaxial rods can be made from aluminum. According to some embodiments, about one-third of the number of rods can be made from carbon steel, about one-third of the number of rods can be made from zinc (or zinc alloys) and about one-third of the number of rods can be made from aluminum.

In some embodiments, more than fourteen tube and rod combinations can be used as part of an electrocoagulation machine 22, and in some embodiments, fewer than fourteen tube and rod combinations can be used as part of an electrocoagulation machine 22.

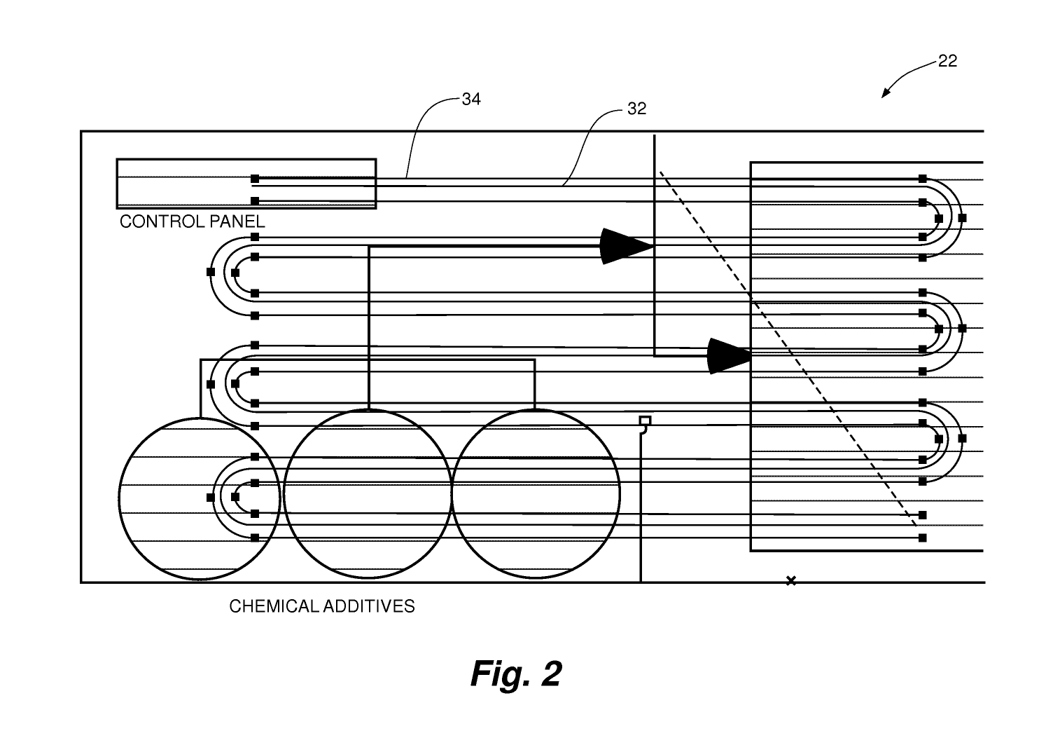

The electrocoagulation machine 22 can be located such that it is suspended from the ceiling of the trailer which contains the first module 14, as depicted in FIG. 2 according to some embodiments. The ratio of stainless steel tubes to carbon steel tubes in a electrocoagulation machine 22 can be customized according to the contaminants observed in the waste water, according to the geographical location of the fracking well head and/or according to the additives that are used in the fracking water. The ratio of carbon steel rods to zinc (or zinc alloy) rods to aluminum rods that are used in an electrocoagulation machine 22 can also be customized according to the contaminants observed in the waste water, according to the geographical location of the fracking well head and/or according to the additives that are used in the fracking water.

After passing through the electrocoagulation machine 22, the waste water can be treated at a chemical additive position 24, according to some embodiments. Chemicals can be added to the water in order to neutralize, and/or coagulate various contaminants. In addition, chemicals can be added to adjust certain characteristics of the water, such as the acid and pH levels, for example.

As part of the water treatment system 12, waste water can also pass through a dissolved air floatation machine 26. Dissolved air flotation is a process that consists of saturating the waste water with air from a compressed air source. In the dissolved air floatation machine 26, compressed air can be introduced into a rapidly moving stream of waste water. The compressed air can be introduced into the tank in the form of tiny air bubbles, and as pressure is removed from the saturated water stream, the air bubbles can attach themselves to the contaminants in the water stream. As some contaminants become attached to air bubbles, this can result in a change in the buoyancy of the contaminants that have become attached. This buoyancy change can cause some of the contaminants to float to the surface of the water, where they can be skimmed from the surface. At the same time, some of the more dense contaminants can sink, where they can be collected from the bottom of the tank. As a result, in some cases, approximately the middle 75% of the waste water that flows through the middle portion of the tank will not need skimming or sediment collection which can be due to the air bubbles that are introduced into the tank.

The waste water can then be piped to the second module 16 which can be contained within a second trailer (e.g., a trailer that is approximately 53 feet long), according to some embodiments. The second module 16 can have a 50-micron filter 36, a sand filter 42, a carbon filter 44, and a 1-micron filter 46. As depicted in FIG. 1, waste water can flow into the second module 16 and be directed through one of two available 50-micron filters 36. As depicted, the two waste water streams that exit the filter 36 can then be recombined into a single stream before again being split into two separate streams, each stream can flow through one sand filter 42 and one carbon filter 44. The two waste water streams can then be recombined into a single stream before again being split into two separate streams that can flow through one of two available 1-micron filters 46. As can be appreciated by those skilled in the art, such a physical layout of piping and filters can have many alternate arrangements. Alternate arrangements can consist of additional or fewer parallel filters (for example, there can be seven 50-micron filters 36, five 50-micron filters 36, or only one 50-micron filter 36; and/or six sand filters 42, three sand filters 42, or only one sand filter 42) and/or alternate piping to deliver the waste water to the filters. Alternate arrangements can be influenced by many factors, which can include, for example, the physical space available, the waste water flow rate, the level of contaminants observed in the untreated waste water, and/or the types of contaminants observed in the untreated waste water.

In some embodiments, 50-micron filters 36 can remove contaminants from the waste stream. The 50-micron filters 36 can have a multi-bag filter media configuration that can use many different forms of media to collect contaminants as the waste water passes through filters 36. Once the media has collected the maximum amount of contaminants, it can be removed and replaced with a new filter media. Of course, other particle sized filters are also possible, and the particle size of the filter media can be selected according to the size of the contaminant to be removed. In some embodiments, different filter media can be selected that can have different levels of particle filtration. Depending on the level of filtration desired, filter media for filter 36 can be selected that has openings that can range from 1 to 300 microns, for example.

The waste water stream can pass through a sand filter 42, according to some embodiments. As the waste water passes through the sand filter 42, contaminants in the water can become attached to the sand particles. The size of the sand particle used in the filter can determine the size of the contaminant that will be captured in the sand filter, consequently, sand particle size can be chosen according to the contaminants observed in the waste water. Once the sand in the sand filter 42 reaches its capacity of contaminants, it can be back-flushed. Back-flushing can allow the sand in the sand filter 42 to be re-used.

The waste water stream can also pass through carbon filters 44, according to some embodiments. The carbon in the carbon filters 44 can collect contaminants in a manner that is similar to how the sand in the sand filters 42 attracts and collects contaminants. Specifically, the carbon can attract and neutralize various emulsified metals, such as benzene, for example. As a result, as the waste water stream passes through carbon filters 44, the waste water is further purified. Once the maximum amount of contaminants have been collected within a carbon filter 44, the filter can be back flushed (similar to back flushing the sand filter) so that the carbon is cleaned and ready for re-use.

In some embodiments, the waste water then passes through 1-micron filters 46. Similar to the 50-micron filters 36, the 1-micron filters 46 can have a multi-bag filter media configuration that can use many different forms of media to collect contaminants as the waste water passes through filters 46. Once the media has collected the maximum amount of contaminants, it can be removed and replaced with a new filter media. Of course, other particle sized filters are also possible, and the particle size of the filter media can be selected according to the size of the contaminant to be removed. In some embodiments, different filter media can be selected that can have different levels of particle filtration. Depending on the level of filtration desired, filter media for filters 46 can be selected that has openings that can range from 1 to 300 microns, for example.

As discussed earlier, each pair of modules is transportable. Once on-site, a pair of modules can be set-up and functional in approximately 2 hours. The waste water treatment system 12 can be configured to treat approximately 300 to 600 gallons of waste water per minute. Treating waste water on-site, as opposed to off-site, has many advantages. Substantial transportation costs can be realized: in addition to saving the costs associated with transporting waste water to an off-site water treatment facility, additional costs of transporting treated water from the off-site water treatment facility to other locations can also be saved. Reducing overall transportation needs also results in a reduction in the wear-and-tear to roads leading to and from a drilling site, which can be very costly to repair due to the remote locations of typical fracking sites. In addition, on-site treatment can permit re-use of treated water for further fracking operations, which can result in a decrease in the dependence on external water sources. On-site treatment can also lead to better acceptance of the fracking operations.

According to some embodiments, water treated by water treatment system 12, can have the following characteristics after treatment: A pH level that can be substantially within the range of 7 to 9; Bacteria has been substantially eliminated; Iron can be substantially at or below 30 parts per million; TDS can be substantially at or below 40 parts per million; and TSS can be substantially at or below 40 parts per million. In addition, substantially 98 percent of any arsenic present before treatment will have been removed and substantially 98 percent of any benzene present before treatment will have been removed.

In the foregoing detailed description, the invention has been described with reference to specific embodiments. However, it may be appreciated that various modifications and changes can be made without departing from the scope of the invention.

What is claimed is:

1. A water treatment system for fracking waste water, the system comprising:
a) a flowback tank adapted to collect fracking waste water,
b) an oil/water separator adapted to separate free and finely dispersed oil droplets from the waste water,
c) an electrocoagulation unit adapted to pass water between two electrically charged metal electrodes in order to promote the coagulation of suspended solid contaminants, and thus their removal,
d) a dissolved air flotation unit adapted to remove coagulated contaminants, and
e) one or more filters selected from the group consisting of a 50 micron bag, a sand filter, a carbon filter, and a 1 micron filter.

2. A system according to claim 1, wherein the system is provided in the form of a plurality of transportable modules, with the one or more filters provided as modules on a second trailer.

3. A method of treating fracking waste water, comprising the steps of providing a system according to claim 1, and operating the system in order to treat fracking water.

4. Fracking water treated by the method of claim 3, the treated water having one or more characteristics selected from the group consisting of a pH level substantially within the range of 7 to 9, the substantial elimination of bacteria, an iron level substantially at or below 30 parts per million, TDS substantially at or below 40 parts per million, and TSS substantially at or below 40 parts per million.
